(19) United States
(12) Patent Application Publication
(10) Pub. No.: US 2014/0212760 A1
(43) Pub. Date: Jul. 31, 2014

(54) MULTI-LAYER THIN CARBON FILMS, ELECTRODES INCORPORATING THE SAME, ENERGY STORAGE DEVICES INCORPORATING THE SAME, AND METHODS OF MAKING SAME

(71) Applicant: BLUESTONE GLOBAL TECH LTD., Wappingers Falls, NY (US)

(72) Inventors: Xin ZHAO, Wappingers Falls, NY (US); Yu-Ming LIN, Wappingers Falls, NY (US)

(73) Assignee: BLUESTONE GLOBAL TECH LTD., Wappingers Falls, NY (US)

(21) Appl. No.: 13/749,749

(22) Filed: Jan. 25, 2013

(51) Int. Cl. H01G 9/00; H01M 4/583; H01M 4/04; H01G 9/04

(52) U.S. Cl. CPC H01G 9/0029; H01G 9/155; H01G 9/058; H01M 4/583; H01M 4/0402
USPC 429/231.8; 361/502; 156/235

(57) ABSTRACT

The invention provides improved paper-like electrodes and electrode active materials for use in flexible energy storage devices, and methods for preparing such electrodes and materials, as well as flexible energy storage devices fabricated from such electrodes and materials and methods of making such devices. The electrodes and electrode active materials comprise multi-layer high-quality thin carbon films, and the methods comprise the use of a repetitive laminar process to deposit such films directly on polymer separators or electrolyte membranes.

### TECHNICAL FIELD

The present invention relates broadly to free-standing and flexible energy storage devices, such as batteries and supercapacitors, and in particular, to electrode materials for such devices, and to methods for the preparation of the same. More specifically, this invention relates to batteries and supercapacitors which incorporate paper-like electrode materials constructed from thin carbon films such as graphene.

### BACKGROUND OF THE INVENTION

In order to cultivate interest in and promote the market penetration of sophisticated and multifunctional “smart” electronics with enhanced functions, such as rollup displays, electronic textiles, wearable gadgets, and printed circuits and devices that can be incorporated into curved objects, flexible energy storage systems with enhanced foldability and conformability must be developed. In recent years, significant progress has been made towards replacing the rigid metallic substrates and packages of conventional batteries and supercapacitors with ones that are light and flexible. However, because conventional battery and supercapacitor geometries are still too bulky and heavy, fully configurable, integratable and reliable energy storage systems are not yet widely available.

The incorporation of carbonaceous nanomaterials such as carbon nanotubes, graphene, and conductive polymers into electronic components presents an appealing approach to enable flexible energy storage devices. In particular, graphene, a two-dimensional planar sheet or monolayer of conjugated carbon atoms, in which the carbon atoms are densely packed in a honeycomb crystal lattice comprising polycyclic aromatic rings with covalently bonded carbon atoms having sp² orbital hybridization, has been demonstrated as an attractive charge storage material and conductive additive in battery and supercapacitor electrodes. Graphene shows improved charge storage capability over other carbon allotropes, which is attributable to its extremely large surface area. In addition, the superior mechanical robustness and integrity of graphene eliminates the need for substrates and polymer binders, and the high electrical conductivity and stability of graphene allows the engineering of flexible, free-standing batteries and supercapacitors without sacrificing the charge/discharge rate capability and without reducing the life cycle of such devices. The removal of inactive substrates and additives further reduces the total weight and volume of the electrodes in such devices, which potentially enables thin and lightweight device designs with improved energy and power output.

To fabricate graphene-based electrodes, previous efforts primarily involved the preparation of graphene-based films or conformal coatings by filtration or wet deposition of graphene nanoplatelets, graphene oxide powders or reduced graphene oxide nanosheets, followed by drying and/or post reduction conversion of the graphene oxide to graphene. The electrodes are then physically stacked with polymer separators into conventional battery or supercapacitor configurations. A recent study proceeded with dip coating of graphene ink onto the surface of macroporous fiber membranes or textiles, which facilitated the direct assembly of electrode materials to the separator membranes. This yielded an integratable and stretchable paper-like supercapacitor that could find applications in wearable electronics and energy harvesting.

However, the discontinuous graphene sheets produced from reduction of graphene oxide precursors, as mentioned above, or even from exfoliation of graphite flakes, suffer from poor mechanical strength, low electrical conductivity, a strong tendency towards agglomeration, and an inability to control the quality and morphology of the graphene, all of which, in turn, hampers the overall charge storage and rate performance. Furthermore, the chemical reduction reactions do not always achieve complete reduction of the graphene oxide precursors, leaving “patches” of graphene oxide that lead to degraded electrical conductivity, thus reducing performance of the resulting electrode material. In addition, the “dip and drying” fabrication of a paper-like supercapacitor or battery electrodes necessitates the utilization of superabsorbent membrane materials, such as cotton sheets, that are prone to aging or oxidation, and hence are proscribed in practical electrochemical systems. Therefore, these device designs may not be applicable in practical circumstances to meet the omnipresent safety requirements. Accordingly, and for all of these reasons, a satisfactory alternative technique is needed for preparing graphene-based electrodes for use in flexible energy storage systems.

It is therefore the principal object of the present invention to provide paper-like electrode materials constructed from thin carbon films such as graphene, and methods for preparing such materials, for use in flexible energy storage systems.

It is another object of the present invention to provide paper-like electrode materials constructed from thin carbon films such as graphene, and methods for preparing such materials, which do not require filtration or wet deposition of graphene nanoplatelets, graphene oxide powders or reduced graphene oxide nanosheets, followed by drying and/or post reduction conversion of the graphene oxide to graphene, and which do not require dip coating of graphene ink onto the surface of macroporous fiber membranes or textiles.

It is yet another object of the present invention to provide a versatile approach to the design of flexible and free-standing paper-like energy storage devices, including aqueous, non-aqueous and solid-state batteries and supercapacitors.

### SUMMARY OF THE INVENTION

These and other objects of the present invention are achieved by providing methods for constructing flexible energy storage systems which comprise the use of a repetitive laminar process to produce multi-layer high-quality thin carbon (i.e., graphene) films. Such films constitute electrode materials that are paper-like and, when directly integrated with polymer separators or electrolyte films, can function as electrodes that can be assembled into batteries and/or supercapacitors that are foldable and conformable. The objects of the present invention are also achieved by providing such paper-like electrode materials for use in flexible energy storage systems, which materials comprise pre-formed combinations of multi-layer graphene films with one or more polymer separators or electrolyte membranes.

More specifically, the methods of the invention for forming paper-like thin carbon film electrodes comprise providing a first thin carbon film layer disposed on a first substrate, providing a second thin carbon film layer disposed on a second substrate, applying a resist composition to the second layer so as to substantially coat the second layer, drying the resist coating, releasing the second layer from the second substrate, positioning the second layer on top of and in contact relationship with the first layer so as to form a stack, removing the resist coating from the top of the stack, and then repeatedly adding further thin carbon film layers to the stack in the same manner until the stack reaches the desired thickness, followed by removing the first substrate from the bottom of the stack and then transferring the remainder of the stack to an isolator, thereby forming the electrode.

Thus, one aspect of the present invention generally concerns improved electrodes and electrode materials for batteries and supercapacitors. One embodiment of this aspect provides the electrode material itself, while another embodiment provides an electrode employing such material, and yet another embodiment of this aspect of the invention provides a battery and/or supercapacitor employing one or more such electrodes.

In still other embodiments of this aspect of the invention, improved flexible, paper-like electrodes for a supercapacitor, for a lithium-ion secondary battery, and for a lithium-air secondary battery are provided, and in still other embodiments of this aspect of the invention, an improved supercapacitor, an improved lithium-ion secondary battery, and an improved lithium-air secondary battery are provided.

Another aspect of the invention generally concerns improved methods for manufacturing supercapacitors, lithium-ion secondary batteries and lithium-air secondary batteries. In one embodiment of this aspect of the invention, a method for preparing a bi- and/or multi-layer thin carbon film for use in electrode materials for such batteries and supercapacitors is provided. In another embodiment of this aspect of the invention, a method for manufacturing an electrode material for such batteries and supercapacitors is provided.

It is a feature of the present invention that it can be used to fabricate a battery or supercapacitor that is fully bendable and stretchable.

It is another feature of the present invention that the use of metal substrates as current collectors and as supports for the electrode material is completely eliminated, resulting in a lightweight device geometry with reduced complexity in packaging.

It is yet another feature of the present invention that since the fabrication procedure does not rely on specific polymer membranes as a device component, commercial polymer separators, gel-electrolyte or solid-electrolyte membranes with excellent mechanical tolerance and chemical sustainability can be incorporated readily, leading to more diverse device formats that can operate in relatively harsh thermal environments, and that are more resistant to tensile deformations and chemical attack.

It is still another feature of the present invention that by using continuous graphene films with large lateral dimensions and long-range ordering, better electron conduction and structural homogeneity can be obtained, as compared with graphene nanoplatelets or reduced graphene oxide nanosheets, thus enhancing the rate capability and cyclability of the flexible energy storage devices produced.

It is a further feature of the present invention that the electrochemical performance of the flexible energy storage devices produced can be further optimized in a well-controlled manner by engineering the structure, surface chemistry and the number of layers of graphene that are used.

### BRIEF DESCRIPTION OF THE DRAWINGS

These and other aspects, features, objects and advantages of the present invention will become more apparent to those skilled in the art from the following detailed description of the presently most preferred embodiments thereof (which are given for the purposes of disclosure), when read in conjunction with the accompanying drawings (which form a part of the specification, but which are not to be considered as limiting its scope), wherein:

FIG. 1 is a schematic view depicting a conventional prior art energy storage system, such as a battery or a supercapacitor;

FIG. 2 is a sequential diagrammatic view depicting the process according to the invention by which a paper-like graphene bi-layer film may be formed on a metallic foil substrate such as copper;

FIG. 3 is a sequential diagrammatic view depicting the process according to the invention by which a paper-like multi-layer graphene-based electrode may be fabricated;

FIG. 4 is an enlarged fragmentary schematic view depicting a flexible symmetric supercapacitor formed in accordance with the invention, having two paper-like multi-layer graphene-based electrodes fabricated according to the process depicted in FIG. 3;

FIG. 5 is an enlarged fragmentary schematic view depicting a flexible lithium-air secondary battery, fabricated in accordance with the invention, having a paper-like multi-layer graphene-based cathode formed according to the process depicted in FIG. 3 and attached to one surface of an isolator, and having a conventional lithium metal foil anode attached to the opposite surface of the isolator;

FIG. 6 a sequential diagrammatic view depicting the process according to the invention by which a multi-layer, graphene-based hybrid electrode may be fabricated;

FIG. 7 is an enlarged fragmentary schematic view depicting a flexible lithium-ion secondary battery fabricated, in accordance with the invention, having a paper-like multi-layer graphene-based hybrid cathode formed according to the process depicted in FIG. 6 and attached to one surface of an isolator, and having a paper-like multi-layer graphene-based anode formed according to the process depicted in FIG. 3 and attached to the opposite surface of the isolator;

FIG. 8 is an enlarged fragmentary schematic view depicting a flexible lithium-ion secondary battery fabricated, in accordance with the invention, having a paper-like multi-layer graphene-based anode formed according to the process depicted in FIG. 3 and attached to one surface of an isolator, and having a conventional cathode, consisting of an aluminum current collector coated with electrochemically active materials, attached to the opposite surface of the isolator; and

FIG. 9 is an enlarged fragmentary schematic view depicting a flexible lithium-ion secondary battery fabricated, in accordance with the invention, having a paper-like multi-layer graphene-based hybrid cathode formed according to the process depicted in FIG. 6 and attached to one surface of an isolator, and having a conventional anode, consisting of a copper current collector coated with electrode active materials, attached to the opposite surface of the isolator.

### DETAILED DESCRIPTION OF THE PREFERRED EMBODIMENT

The preferred and other embodiments of each aspect of the present invention will now be further described. Although the invention will be illustratively described hereinafter with reference to the formation of a graphene film on a copper foil substrate, it should be understood that the invention is not limited to the specific case described, but extends also to the formation of graphene films utilizing other metallic foils (including nickel foils or aluminum foils) or other substrates.

Referring first to FIG. 1, the structure and configuration of a conventional prior art energy storage system 1 (i.e., a battery or a supercapacitor) is depicted schematically, in which a conventional anode material 2 positioned adjacent an associated conventional anode current collector 3, as well as a conventional cathode material 4 positioned adjacent an associated conventional cathode current collector 5, are physically stacked in a package 6, with the electrolyte 7 and a polymer separator 8 positioned in between the electrodes (i.e., between anode material 2 and cathode material 4). Although current collectors 3 and 5, which are generally formed from metallic substrates, and package 6 itself are usually thin, none of them is bendable or stretchable to any great degree, and therefore the resulting battery or supercapacitor 1 is not particularly flexible and is ill-suited for use in flexible electronic devices.

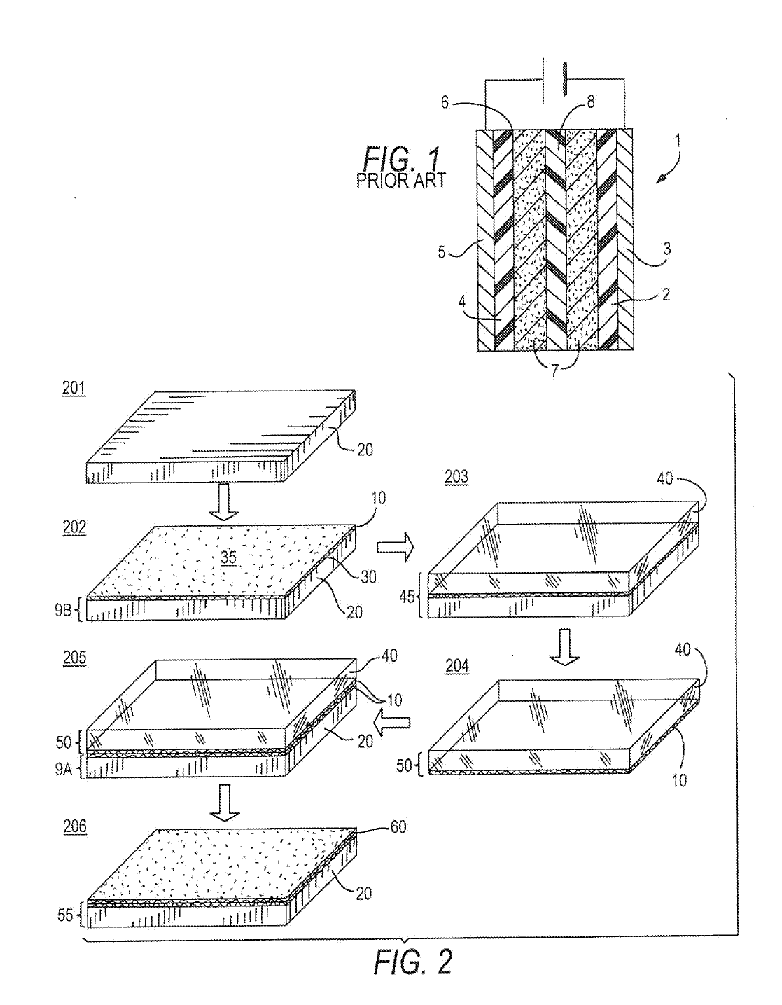

Referring now to FIG. 2 in addition to the aforementioned FIG. 1, the preferred embodiments of the present invention will now be described. One aspect of the invention relates to a multi-layer thin carbon film, and in particular, a bi-layer graphene film, that may be fabricated in accordance with the invention by the process depicted in FIG. 2. That process initially comprises either providing, or forming, two instances of a first precursor material 9 (these two instances are respectively designated 9A and 9B in FIG. 2). First precursor material 9 comprises a graphene film 10 comprised of either a unitary monolayer of graphene, or no more than about five monolayers of graphene, supported on a surface of a generally flat copper foil substrate 20; the copper foil substrate 20 is shown schematically at step 201 in FIG. 2, prior to the formation of first precursor material 9.

The graphene film 10 may be formed, as shown at step 202 in FIG. 2, by any known process, such as, for example, via chemical vapor deposition in a conventional CVD furnace (not shown) at a temperature in the range of 500-1,200 degrees C., and preferably at about 1,000 degrees C., in the manner described generally in prior art U.S. Patent Application Publication No. 2011/0091647, although alternative vapor deposition processes such as PECVD or ALD may be used. For the purposes of the present invention, the area of the copper foil substrate 20 on which the graphene film 10 is formed preferably may range from approximately 1 cm×1 cm to approximately 10 m×100 m, and the thickness of the copper foil substrate 20 preferably may range from approximately 1 μm to approximately 1,000 μm. As can be seen in FIG. 2, within first precursor material 9, graphene film 10 has a first surface 30 that is positioned adjacent the surface of copper foil substrate 20, and a second surface 35 that is not adjacent substrate 20 and is exposed.

In the next step in the fabrication process, substantially the entire exposed second surface 35 of one instance (instance B) of first precursor material 9 is then coated with a layer of a polymeric photo-resist 40, thus creating a second precursor material 45, as shown at step 203 in FIG. 2. Preferably, the polymeric photo-resist layer 40 is composed of polymethylmethacrylate (“PMMA”), which is available commercially, dissolved in anisole in a variety of concentrations, from a number of manufacturers, such as MicroChem. Corp. of Newton, Mass., U.S.A., which markets this material in bottle form. For the purposes of the present invention, any concentration of PMMA up to about 60% may be used, although the concentration that is preferred ranges from about 0.5% to about 20%. The PMMA may be coated onto the second surface 35 of first precursor material 9 either by spray coating, or by spin-coating, or even by dipping (i.e., immersing) the graphene film directly into the PMMA solution (each of these methods is well known in the art, and therefore none of them is illustrated in the drawings). Regardless of which coating method is used, however, the polymeric photo-resist layer 40 is thereafter either dried by baking, or by allowing it to air dry. The purpose of the polymeric coating 40 is to provide additional support for the graphene film 10 during subsequent steps in the fabrication process.

Thereafter, as shown at step 204 in FIG. 2, the copper foil substrate 20 is removed from the second precursor material 45 preferably via etching, using conventional copper etching materials which are commercially available. For example, an acidic solution or an oxidizing agent may be used to etch away the copper foil substrate 20, thereby releasing the graphene film 10 which, with the polymeric photo-resist layer 40 still attached, forms a third precursor material 50. Etching techniques by which to remove the copper foil substrates on which graphene films have been deposited are well known in the art, and therefore will not be further described herein.

Following the release of the graphene film 10 from the copper foil substrate 20 (i.e., after the etching step is complete), the resulting third precursor material 50 is physically stacked, as shown at step 205 in FIG. 2, upon the other instance (instance A) of first precursor material 9, such that the released side of graphene film 10 in third precursor material 50 is positioned adjacent to the exposed surface 35 of the graphene film in instance A of first precursor material 9. After the stacking step, the polymeric coating 40 is then removed or eliminated, preferably by rinsing in an organic solvent such as acetone, yielding a resulting first composite material 55, as shown at step 206 in FIG. 2, which comprises a graphene bi-layer film 60 attached to a copper foil substrate. This first composite material 55 may then be used directly, with the copper foil substrate still attached, or the graphene bi-layer film 60 may be separated or transferred from the substrate in a known manner (not shown), preferably via etching, and then the separated graphene bi-layer 60 may be utilized in a graphene application or otherwise further processed for ultimate use.

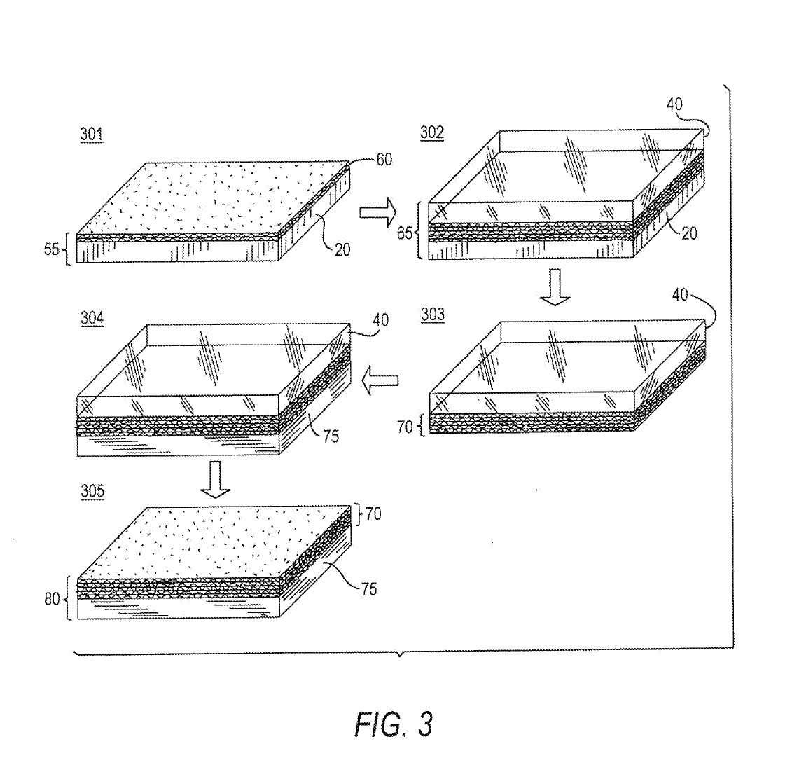

Referring now to FIG. 3 in addition to the aforementioned FIGS. 1 and 2, another aspect of the present invention relates to paper-like multi-layer thin carbon film electrodes for use in flexible energy storage systems. In a preferred embodiment, a multi-layer graphene film electrode may be fabricated in accordance with the invention by a process which comprises initially preparing the composite material 55, in accordance with the procedure described above in connection with FIG. 2 for formation of a bi-layer graphene film, which thereafter serves as a base during subsequent steps in the fabrication process, as shown at step 301 in FIG. 3. Then, further graphene film layers are added to that base in a laminar fashion, first by repeating stacking step 205, utilizing in each repetition a new instance of third precursor material 50 (which, as will be evident to those skilled in the art, may itself be prepared separately from yet another new instance of first precursor material 9, using the coating step 203 and the etching step 204 described above), and then by repeating the removal step 206 to eliminate the polymeric coating 40 from the resulting composite via rinsing (these repetitions of steps 205 and 206 are not shown in FIG. 3), until the desired number of graphene film layers is reached, thereby forming a second composite material 65, as shown at step 302 in FIG. 3.

As will be apparent to those skilled in the art, the number of repetitions used will be determined by the desired properties or the field of application of the electrode and/or energy storage device being fabricated. It should be understood, however, that the resulting second composite material 65 will include a copper foil substrate 20 coated with a multi-layer graphene film comprising up to as many as about 1 million monolayers graphene sheets). After the desired number of layers has been produced, the copper foil substrate underlying the base is then removed from the second composite material 65, again preferably via etching, as shown at step 303 in FIG. 3, leaving the multi-layer graphene film 70 which also constitutes an electrode active material that can be utilized as a graphene-based electrode.

In order to use it in a supercapacitor or a battery, electrode 70 may then be transferred, as shown at step 304 in FIG. 3, to one side of a flexible isolator 75, which comprises either a polymer separator or a solid-state polymer electrolyte film. The polymer separator can be a porous membrane that may preferably be made from any one of several materials, including but not limited to polyethylene, polypropylene and glass fiber. Such separators are commercially available from a wide variety of sources such as Celgard, LLC of Charlotte, N.C., U.S.A. and Membrana GmbH of Wuppertal, Germany. The solid-state polymer electrolyte film may be, for example, a gel polymer electrolyte, which preferably may be formed from any one of several polymer film materials, including, but not limited to, and most preferably selected from, the group consisting of poly(vinylidene fluoride-co-hexafluoropropene), poly(ethylene oxide), poly(propylene oxide) and poly(acrylonitrile) films, in which one or more of the lithium salts is dissolved, the lithium salt(s) preferably being selected from the group consisting of LiPF₆, LiBF₄, LiClO₄, LiAlO₂ and LiCF₃SO₃. Such polymer film materials and lithium salts are commercially available from a variety of sources including Kureha Corporation of Tokyo, Japan, from which the polymer film materials may be obtained, and Honeywell International Inc. of Danbury, Conn., U.S.A., from which the lithium salts may be obtained.

Following transfer to isolator 75, the polymeric coating 40 is removed, again preferably by rinsing in an organic solvent such as acetone, yielding a product 80, as shown at step 305 in FIG. 3, which may advantageously be incorporated into, and actually form a part of, an energy storage device such as a supercapacitor or a lithium-ion battery or lithium-air battery, as described below.

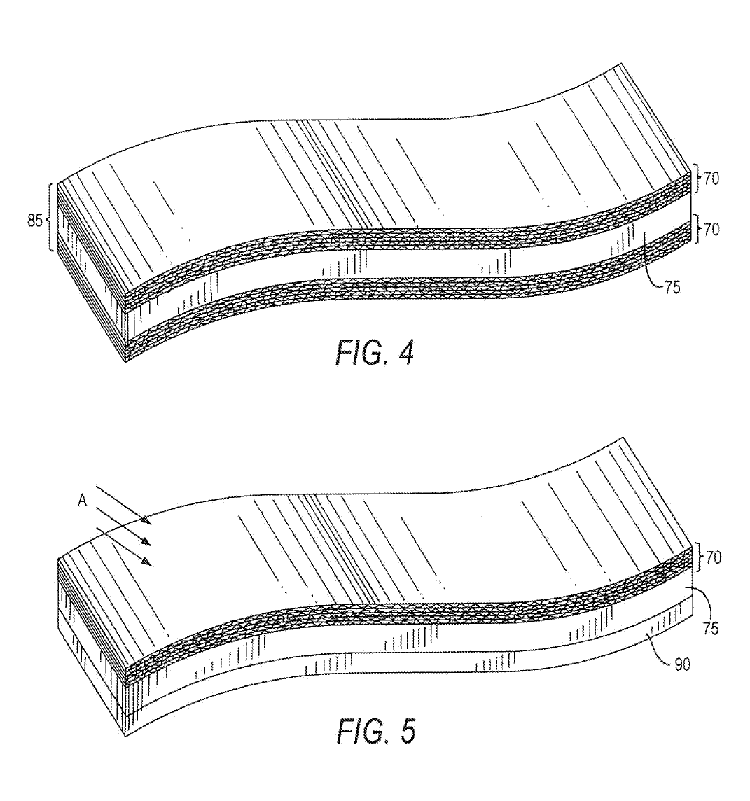

Referring now to FIGS. 4 and 5 in addition to the aforementioned FIGS. 1-3, a flexible symmetric supercapacitor device, which constitutes yet another aspect of the invention, may be formed by attaching a graphene-based electrode 70, fabricated in accordance with the invention, to both surfaces of either a polymer separator or a solid-state polymer electrolyte film, as shown in FIG. 4. In other words, after the graphene-based electrode 70 is formed and is attached to one surface of isolator 75 as described above (at steps 304 and 305 in FIG. 3), thereby forming the product 80, a second, separate multi-layer graphene film electrode 70 may be produced in the same manner (this second production process is not shown in the drawings), after which the second multi-layer graphene film electrode may be transferred to the opposite surface of isolator 75 of product 80, resulting in the isolator 75 being “sandwiched” between two graphene-based electrodes. This flexible laminar sandwich 85 functions as a supercapacitor, i.e., it may be charged by connecting the electrodes to a source of electrical current, and it will retain that charge until it is discharged.

Similarly, as shown in FIG. 5, a flexible lithium-air secondary battery, which constitutes still another aspect of the invention, may be formed by attaching a graphene-based electrode 70, fabricated in accordance with the invention, to one surface of an isolator, first by attaching the electrode to an isolator 75 (thereby forming the product 80), as described above, and then by attaching a lithium metal foil 90 to the opposite surface of the isolator. Such lithium foils are commercially available from a variety of sources such as Sigma-Aldrich Co. LLC of St. Louis, Mo., U.S.A. and Alfa Aesar of Ward Hill, Mass., U.S.A. In this configuration, the graphene-based electrode acts as a catalytic cathode for oxygen reduction and evolution reactions, while the lithium metal foil 90 functions as an anode.

The morphology and composition of the graphene-based cathode can be engineered so as to achieve the optimum capacity and rate performance for such a lithium-air secondary battery. For example, in order to accelerate oxygen diffusion (which is depicted by the arrows A in FIG. 5), in-plane pores can be introduced into the graphene layers by physical irradiation with energetic molecules, such as electron or ion beams, or by chemical etching with potassium hydroxide or by acid activation. As another example, in order to enhance the catalytic properties of the graphene-based cathode, heteroatoms such as nitrogen and/or boron can be introduced into the graphene layers by heat treatment of the graphene in nitrogen- and/or boron-containing gases, such as ammonia (NH₃) and/or boron chloride (BCl₃).

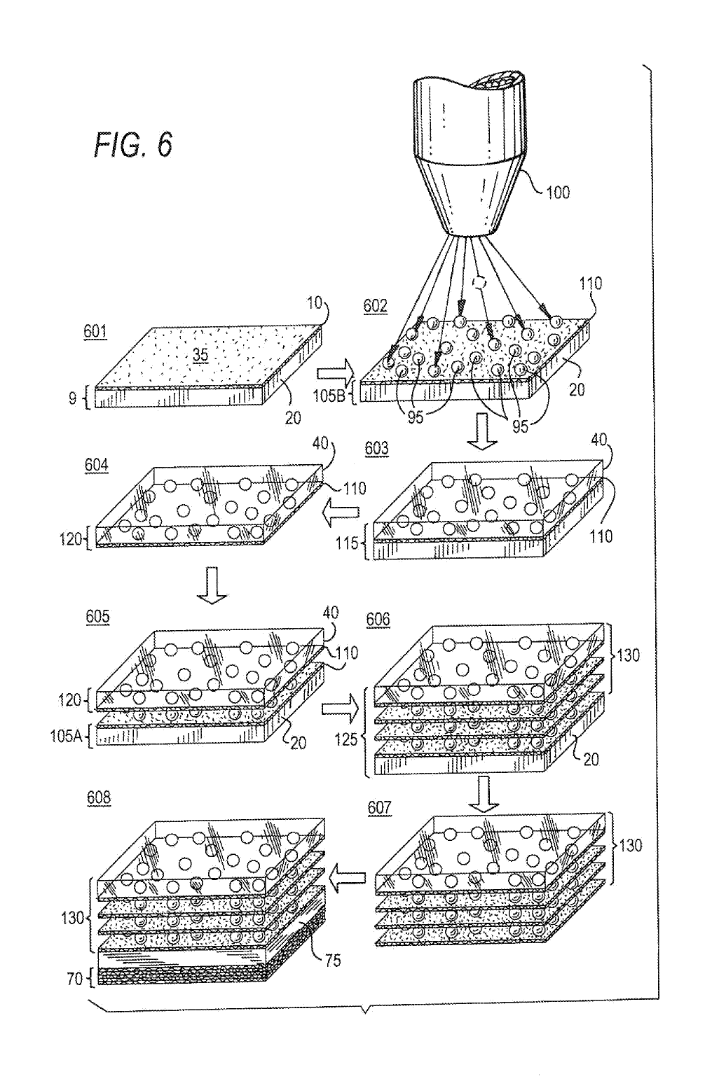

Referring now to FIG. 6 in addition to the aforementioned FIGS. 1-5, another aspect of the invention relates to the assembly of a multi-layer graphene-based hybrid electrode, which can be assembled in a laminar manner similar to that shown in FIG. 3 for the assembly of a multi-layer graphene-based (non-hybrid) electrode. As shown at step 601 in FIG. 6, the fabrication process initially comprises either providing, or forming, two instances of first precursor material 9 (for ease of illustration, only one instance is shown in FIG. 6). Thereafter, nanoparticles 95 of one or more electrochemically active materials preferably comprised of lithium metal salts, and more preferably selected from among lithium metal oxides and lithium metal phosphates (such as LiMn₂O₄, LiCoO₂, or LiFePO₄), the particles ranging in diameter from approximately 1 nm to approximately 1 mm, are deposited onto the exposed second surface 35 of graphene film 10 of first precursor material 9. Such electrochemically active materials are commercially available from a number of sources such as Umicore Group of Brussels, Belgium and Tronox Limited of Stamford, Conn., U.S.A., but can alternatively be fabricated directly via chemical routes, such as solid state calcination, solution phase precipitation and/or sol-gel methods.

Preferably, and as shown at step 602 in FIG. 6 (but illustratively for only one instance of first precursor material 9), nanoparticles 95 are deposited onto the exposed surface of the graphene film via spray coating through a nozzle 100, followed by air drying, although other application methods may be used, such as spin-coating or even dip-coating (i.e., immersing) the graphene film directly into the particles, and thereafter allowing it to air dry (these alternative methods are not shown in the drawings, as they are well known in the art). The application of the electrochemically active materials to surface 35 of both instances of first precursor material 9 creates two instances of a tri-layer first hybrid precursor material 105, each comprising a hybrid graphene-nanoparticle film 110 supported on a copper foil substrate 20 (these instances are respectively designated 105A and 105B in FIG. 6).

The next step in the fabrication process is to coat the hybrid graphene film 110 in one instance (instance B) of tri-layer first hybrid precursor material 105 with a layer of a polymeric photo-resist 40, as shown at step 603 in FIG. 6, in the same manner as described above in connection with FIG. 2, thus creating a second hybrid precursor material 115.

Thereafter, as shown at step 604 in FIG. 6, the copper foil substrate 20 is removed from second hybrid precursor material 115 via etching, thereby releasing hybrid graphene film 110 which, with the polymeric photo-resist layer 40 still attached, forms a third hybrid precursor material 120. Following the release of hybrid graphene film 110 from the copper foil substrate 20 (i.e., after the etching step is complete), the resulting third hybrid precursor material 120 is physically stacked, as shown at step 605 in FIG. 6, upon the other instance (instance A) of tri-layer first hybrid precursor material 105, such that the released side of hybrid graphene film 110 in third hybrid precursor material 120 is positioned adjacent to the exposed surface of the hybrid graphene film in instance A of first hybrid precursor material 105. After this stacking step, the polymeric photo-resist layer 40 is then removed by rinsing (this step is not shown in the drawings), yielding a product which thereafter serves as a base during subsequent steps in the fabrication process.

Then, further hybrid graphene film layers are added to that base in a laminar fashion, first by repeating stacking step 605, utilizing in each repetition a new instance of third hybrid precursor material 120 (which, as will be evident to those skilled in the art, may itself be prepared separately from a new instance of first hybrid precursor material 105, using the coating step 603 and the etching step 604 described above), and then by repeating the removal step (not shown in the drawings) to eliminate the polymeric photo-resist layer 40 from the resulting composite via rinsing (these repetitions of step 605 and the removal step are not shown in FIG. 6), until the desired number of hybrid graphene film layers is reached, thereby forming a hybrid composite material 125 which includes a copper foil substrate coated with a multi-layer hybrid graphene film 130 comprising up to as many as about 1 million graphene monolayers with embedded electrochemically active nanoparticles, as shown at step 606 in FIG. 6. After the desired number of layers has been produced, the copper foil substrate 20 underlying the base is then removed, as shown at step 607 in FIG. 6, from hybrid composite material 125, again preferably via etching, leaving the multi-layer hybrid graphene film 130 which also constitutes an electrode active material that can be utilized as a multi-layer graphene-based hybrid electrode.

In order to use it in a lithium-ion secondary battery, electrode 130 may then be transferred, as shown at step 608 in FIG. 6, to one side of a flexible isolator 75, which again comprises either a polymer separator or a solid-state polymer electrolyte film, as mentioned above. Following this transfer to isolator 75, the polymeric coating 40 is removed, again preferably by rinsing in an organic solvent such as acetone (this removal step is not shown in the drawings).

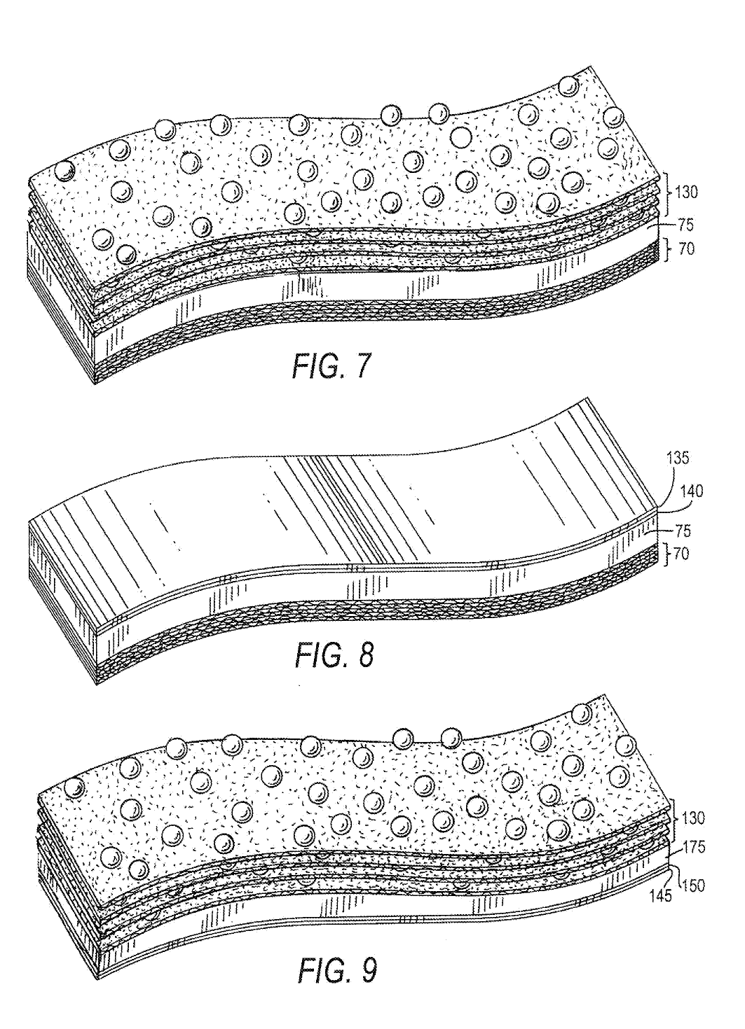

Referring now to FIGS. 7-9 in addition to the aforementioned FIGS. 1-6, several different flexible lithium-ion secondary batteries with paper-like electrodes may also be formed in accordance with, and constitute still further aspects of, the invention. As shown in FIG. 7, a flexible lithium-ion secondary battery with a pair of paper-like electrodes may be formed by attaching a multi-layer graphene-based hybrid electrode 130, fabricated in accordance with the invention, to one surface of an isolator 75, thus forming the cathode, and by attaching to the opposite surface of isolator 75 a multi-layer graphene-based (non-hybrid) electrode 70, which functions as the anode for lithium ion storage. As shown at step 608 in FIG. 6, this assembly can best be accomplished by attaching (via an evaporation transfer procedure) electrode 130, formed as described above in connection with FIG. 6, to one side of an isolator 75, which already carries a multi-layer graphene-based (non-hybrid) electrode 70, formed as described above in connection with FIG. 3, on its opposite side. The graphene-based hybrid electrode 130 may comprise only a single hybrid graphene-nanoparticle layer, or a vast number of such layers (e.g., up to as many as about 1 million layers), resulting in a total thickness ranging from about 1 nm to about 1 mm, and as will be apparent to those skilled in the art, the number of layers (i.e., the film thickness), as well as the amount of the electrochemically active material introduced and the assembly conditions such as the coating parameters (e.g., the coating velocity and drying temperature), can each be varied in order to maximize the homogeneity and utility of electrode 130, and thereby optimize its performance.

Furthermore, as shown in FIGS. 8 and 9, flexible lithium-ion batteries with a single paper-like electrode are also within the scope of the invention. In one embodiment, as illustrated in FIG. 8, the anode can comprise a multi-layer graphene-based electrode 70 supported on an isolator 75 and formed in accordance with the invention, while the cathode can conventionally comprise an aluminum current collector 135 coated with electrochemically active materials 140 (such as LiMn₂O₄, LiCoO₂, or LiFePO₄, as mentioned above) in powder form. In another alternative, as depicted in FIG. 9, the cathode can comprise a multi-layer graphene-based hybrid electrode 130 supported on an isolator 75 and formed in accordance with the invention, while the anode can conventionally comprise a copper current collector 145 coated with electrode active materials 150 such as, for example, intercalation carbon materials (e.g., graphite, carbon nanotubes or carbon nanospheres), metals (e.g., silicon [Si], germanium [Ge] or tin [Sn]), transition metal oxides (e.g., tin dioxide [SnO₂], iron oxide [FeₓO_{y}] or manganese dioxide [MnO₂]), electrically conducting polymeric materials (e.g., polyaniline [“PANi”], polypyrrole [“PPy”] or poly(3,4-ethylenedioxythiophene) [“PEDOT”]), or alloy powders (e.g., silicon-germanium [Si—Ge] alloy or silicon-iron [Si—Fe] alloys). As those skilled in the art will understand, all of these materials are conventional electrode active materials which are available commercially or can be fabricated by conventional chemical methods.

While there has been described what are at present considered to be the preferred embodiments of the present invention, it will be apparent to those skilled in the art that the embodiments described herein are by way of illustration and not of limitation. Various modifications of the disclosed embodiments, as well as alternative embodiments of the invention, will become apparent to persons skilled in the art upon reference to the description of the invention. Therefore, it is to be understood that various changes and modifications may be made in the embodiments disclosed herein without departing from the true spirit and scope of the present invention, as set forth in the appended claims, and it is contemplated that the appended claims will cover any such modifications or embodiments.

1. A method for fabricating an electrode for use in an energy storage device, the method comprising the steps of
(a) forming a first thin carbon film layer on a first substrate;
(b) forming a second thin carbon film layer on a second substrate;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further thin carbon film layers to said stack until said stack reaches a desired thickness; and
(i) releasing said first substrate from the bottom of said stack so as to form said electrode.

2. The method of claim 1 wherein step (c) further comprises depositing at least one electrochemically active material onto said first layer and, prior to applying said resist composition, depositing at least one electrochemically active material onto said second layer.

3. The method of claim 2 wherein each said depositing step is followed by a drying step, and wherein each said depositing step comprises a step selected from the group consisting of spray coating, spin-coating and immersion.

4. The method of claim 3 wherein said at least one electrochemically active material is selected from the group consisting of lithium metal oxides and lithium metal phosphates.

5. The method of claim 1 or claim 4 wherein said substrates comprise copper foil and wherein said thin carbon films comprise graphene.

6. A method for fabricating an electrode for use in an energy storage device, the method comprising the steps of
(a) providing a first substrate having a first thin carbon film layer disposed on one surface thereof;
(b) providing a second substrate having a second thin carbon film layer disposed on one surface thereof;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further thin carbon film layers to said stack until said stack reaches a desired thickness; and
(i) releasing said first substrate from the bottom of said stack so as to form said electrode.

7. The method of claim 6 wherein step (c) further comprises depositing at least one electrochemically active material onto said first layer and, prior to applying said resist composition, depositing at least one electrochemically active material onto said second layer.

8. The method of claim 7 wherein each said depositing step is followed by a drying step, and wherein each said depositing step comprises a step selected from the group consisting of spray coating, spin-coating and immersion.

9. The method of claim 8 wherein said at least one electrochemically active material is selected from the group consisting of lithium metal oxides and lithium metal phosphates.

10. The method of claim 6 or claim 9 wherein said substrates comprise copper foil and wherein said thin carbon films comprise graphene.

11. A method for fabricating a graphene-based electrode for use in an energy storage device, the method comprising the steps of
(a) forming a first graphene film layer on a first substrate;
(b) forming a second graphene film layer on a second substrate;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further graphene film layers to said stack until said stack reaches a desired thickness; and
(i) releasing said first substrate from the bottom of said stack so as to form said electrode.

12. The method of claim 11 wherein step (c) further comprises depositing at least one electrochemically active material onto said first layer and, prior to applying said resist composition, depositing at least one electrochemically active material onto said second layer.

13. The method of claim 12 wherein each said depositing step is followed by a drying step, and wherein each said depositing step comprises a step selected from the group consisting of spray coating, spin-coating and immersion.

14. The method of claim 13 wherein said at least one electrochemically active material is selected from the group consisting of lithium metal oxides and lithium metal phosphates.

15. The method of claim 11 or claim 14 wherein said substrates comprise copper foil.

16. A method for fabricating a graphene-based electrode for use in an energy storage device, the method comprising the steps of
(a) providing a first substrate having a first thin carbon film layer disposed on one surface thereof;
(b) providing a second substrate having a second thin carbon film layer disposed on one surface thereof;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further graphene film layers to said stack until said stack reaches a desired thickness; and
(i) releasing said first substrate from the bottom of said stack so as to form said electrode.

17. The method of claim 16 wherein step (c) further comprises depositing at least one electrochemically active material onto said first layer and, prior to applying said resist composition, depositing at least one electrochemically active material onto said second layer.

18. The method of claim 17 wherein each said depositing step is followed by a drying step, and wherein each said depositing step comprises a step selected from the group consisting of spray coating, spin-coating and immersion.

19. The method of claim 18 wherein said at least one electrochemically active material is selected from the group consisting of lithium metal oxides and lithium metal phosphates.

20. The method of claim 16 or claim 19 wherein said substrates comprise copper foil.

21. The method of any one of claim 1-4, 6-9, 11-14 or 16-19 further comprising, after step (i), transferring the remainder of said stack to a surface of an isolator.

22. A method for manufacturing a supercapacitor comprising (a) forming two electrodes, each electrode being formed using a method as defined in any one of claim 1, 6, 11 or 16, (b) transferring one of said electrodes to one surface of an isolator, and (c) transferring the other said electrode to the opposed surface of said isolator.

23. A method for manufacturing a lithium-air secondary battery comprising (a) forming an electrode using a method as defined in any one of claim 1, 6, 11 or 16, (b) transferring said electrode to one surface of an isolator so as to form a cathode, and (c) attaching a lithium metal foil anode to the opposed surface of said isolator, wherein step (c) may be performed prior to step (a).

24. A method for manufacturing a lithium-ion secondary battery comprising (a) preparing a first electrode using a method as defined in any one of claim 2-4, 7-9, 12-14 or 17-19, (b) transferring said first electrode to one surface of an isolator so as to form an anode, (c) preparing a second electrode using a method as defined in any one of claim 2-4, 7-9, 12-14 or 17-19, and (d) transferring said second electrode to the opposed surface of an isolator so as to form a cathode, wherein step (c) may be performed prior to step (b), or wherein steps (c) and (d) may be performed prior to steps (a) and (b).

25. A method for manufacturing a lithium-ion secondary battery comprising (a) forming an electrode using a method as defined in any one of claim 2-4, 7-9, 12-14 or 17-19, (b) transferring said electrode to one surface of an isolator so as to form an anode, and (c) attaching an aluminum current collector coated with an electrochemically active material to the opposed surface of said isolator so as to form a cathode, wherein step (c) may be performed prior to step (a).

26. A method for manufacturing a lithium-ion secondary battery comprising (a) forming an electrode using a method as defined in any one of claim 2-4, 7-9, 12-14 or 17-19, (b) transferring said electrode to one surface of an isolator so as to form a cathode, and (c) attaching to the opposed surface of said isolator so as to form an anode a copper current collector coated with a material selected from the group consisting of intercalation carbon materials, metals, transition metal oxides, electrically conducting polymeric materials, and alloy powders, wherein step (c) may be performed prior to step (a).

27. An electrode for an energy storage device, said electrode formed using a method as defined in any one of claim 1-4, 6-9, 11-14 or 16-19.

28. An energy storage device employing the electrode of claim 27.

29. A method for producing an electrode active material for use in an energy storage device, the method comprising the steps of
(a) forming a first thin carbon film layer on a first substrate;
(b) forming a second thin carbon film layer on a second substrate;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further thin carbon film layers to said stack until said stack reaches a desired thickness; and
(i) releasing said first substrate from the bottom of said stack so as to form said electrode active material.

30. The method of claim 29 wherein step (c) further comprises depositing at least one electrochemically active material onto said first layer and, prior to applying said resist composition, depositing at least one electrochemically active material onto said second layer.

31. The method of claim 30 wherein each said depositing step is followed by a drying step, and wherein each said depositing step comprises a step selected from the group consisting of spray coating, spin-coating and immersion.

32. The method of claim 31 wherein said at least one electrochemically active material is selected from the group consisting of lithium metal oxides and lithium metal phosphates.

33. The method of claim 29 or claim 32 wherein said substrates comprise copper foil and wherein said thin carbon films comprise graphene.

34. A method for producing an electrode active material for use in an energy storage device, the method comprising the steps of (a) providing a first substrate having a first thin carbon film layer disposed on one surface thereof;
(b) providing a second substrate having a second thin carbon film layer disposed on one surface thereof;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further thin carbon film layers to said stack until said stack reaches a desired thickness; and
(i) releasing said first substrate from the bottom of said stack so as to form said electrode active material.

35. The method of claim 34 wherein step (c) further comprises depositing at least one electrochemically active material onto said first layer and, prior to applying said resist composition, depositing at least one electrochemically active material onto said second layer.

36. The method of claim 35 wherein each said depositing step is followed by a drying step, and wherein each said depositing step comprises a step selected from the group consisting of spray coating, spin-coating and immersion.

37. The method of claim 36 wherein said at least one electrochemically active material is selected from the group consisting of lithium metal oxides and lithium metal phosphates.

38. The method of claim 34 or claim 37 wherein said substrates comprise copper foil and wherein said thin carbon films comprise graphene.

39. A method for producing a graphene-based electrode active material for use in an energy storage device, the method comprising the steps of
(a) forming a first graphene film layer on a first substrate;
(b) forming a second graphene film layer on a second substrate;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further graphene film layers to said stack until said stack reaches a desired thickness; and
(i) releasing said first substrate from the bottom of said stack so as to form said electrode active material.

40. The method of claim 39 wherein step (c) further comprises depositing at least one electrochemically active material onto said first layer and, prior to applying said resist composition, depositing at least one electrochemically active material onto said second layer.

41. The method of claim 40 wherein each said depositing step is followed by a drying step, and wherein each said depositing step comprises a step selected from the group consisting of spray coating, spin-coating and immersion.

42. The method of claim 41 wherein said at least one electrochemically active material is selected from the group consisting of lithium metal oxides and lithium metal phosphates.

43. The method of claim 39 or claim 42 wherein said substrates comprise copper foil.

44. A method for producing a graphene-based electrode active material for use in an energy storage device, the method comprising the steps of
(a) providing a first substrate having a first thin carbon film layer disposed on one surface thereof;
(b) providing a second substrate having a second thin carbon film layer disposed on one surface thereof;
(c) applying a resist composition to said second layer so as to substantially coat said second layer;
(d) drying said resist coating;
(e) releasing said second substrate;
(f) positioning said second layer on top of and in contact relationship with said first layer so as to form a stack;
(g) removing said resist coating from the top of said stack;
(h) repeating steps (b) to (g) so as to add further graphene film layers to said stack until said stack reaches a desired thickness; and
(i) releasing said first substrate from the bottom of said stack so as to form said electrode active material.

45. The method of claim 44 wherein step (c) further comprises depositing at least one electrochemically active material onto said first layer and, prior to applying said resist composition, depositing at least one electrochemically active material onto said second layer.

46. The method of claim 45 wherein each said depositing step is followed by a drying step, and wherein each said depositing step comprises a step selected from the group consisting of spray coating, spin-coating and immersion.

47. The method of claim 46 wherein said at least one electrochemically active material is selected from the group consisting of lithium metal oxides and lithium metal phosphates.

48. The method of claim 44 or claim 47 wherein said substrates comprise copper foil.

49. The method of any one of claim 29-32, 34-37, 39-42 or 44-47, further comprising, after step (i), transferring the remainder of said stack to a surface of an isolator.

50. A method for manufacturing a supercapacitor comprising (a) preparing two electrode active materials, each said electrode active material being formed using a method as defined in any one of claim 29, 34, 39 or 44, (b) forming an electrode from one said electrode active material on one surface of an isolator, and (c) forming an electrode from the other said electrode active material on the opposed surface of said isolator.

51. A method for manufacturing a lithium-air secondary battery comprising (a) preparing an electrode active material using a method as defined in any one of claim 29, 34, 39 or 44, (b) forming a cathode from said electrode active material on one surface of an isolator, and (c) attaching a lithium metal foil anode to the opposed surface of said isolator, wherein step (c) may be performed prior to step (a).

52. A method for manufacturing a lithium-ion secondary battery comprising (a) preparing a first electrode active material using a method as defined in any one of claim 30-32, 35-37, 40-42 or 45-47, (b) forming an anode from said first electrode active material on one surface of an isolator, (c) preparing a second electrode active material using a method as defined in any one of claim 30-32, 35-37, 40-42 or 45-47, and (d) forming a cathode from said second electrode active material on the opposed surface of an isolator, wherein step (c) may be performed prior to step (b), or wherein steps (c) and (d) may be performed prior to steps (a) and (b).

53. A method for manufacturing a lithium-ion secondary battery comprising (a) preparing an electrode active material using a method as defined in any one of claim 30-32, 35-37, 40-42 or 45-47, (b) forming an anode from said electrode active material on one surface of an isolator, and (c) attaching an aluminum current collector coated with an electrochemically active material to the opposed surface of said isolator so as to form a cathode, wherein step (c) may be performed prior to step (a).

54. A method for manufacturing a lithium-ion secondary battery comprising (a) preparing an electrode active material using a method as defined in any one of claim 30-32, 35-37, 40-42 or 45-47, (b) forming a cathode from said electrode active material on one surface of an isolator, and (c) attaching to the opposed surface of said isolator so as to form an anode a copper current collector coated with a material selected from the group consisting of intercalation carbon materials, metals, transition metal oxides, electrically conducting polymeric materials, and alloy powders, wherein step (c) may be performed prior to step (a).

55. An electrode active material formed using a method as defined in any one of claim 29-32, 34-37, 39-42 or 44-47.

56. An electrode for an energy storage device, said electrode employing the electrode active material of claim 55.

57. An energy storage device employing the electrode of claim 56.
